(19) United States
(12) Patent Application Publication
(10) Pub. No.: US 2014/0339730 A1
(43) Pub. Date: Nov. 20, 2014

(54) METHOD AND DEVICE FOR PRODUCING A FOOTBED FOR A SHOE

(71) Applicants: Julia Stoehr, Gmunden (AT); Norbert Hessenberger, Ohlsdorf (AT)

(72) Inventors: Julia Stoehr, Gmunden (AT); Norbert Hessenberger, Ohlsdorf (AT)

(21) Appl. No.: 14/344,366

(22) PCT Filed: Sep. 3, 2012
(86) PCT No.: PCT/AT2012/050122

§ 371 Date: Mar. 12, 2014

(30) Foreign Application Priority Data
Sep. 20, 2011 (AT) A 1349/2011

(51) Int. Cl. B29C 45/00; B29D 35/00

(52) U.S. Cl. CPC B29C 45/0003; B29D 35/0018; B29L 2009/00
USPC 264/250; 425/119

(57) ABSTRACT

A method is described for producing a footbed for a shoe having an open planar formation (5), which absorbs tensile forces, and which is held freely stretched in a support frame (4), which defines the edge profile of the footbed, with the aid of a cover frame (9). To provide an advantageous bond between the planar formation (5) and the support frame (4), it is proposed that the cover frame (9) be molded in an integrally joined manner through the open planar formation (5) onto the support frame during its production from a plastic melt.

### 1. FIELD OF THE INVENTION

The invention relates to a method for producing a footbed for a shoe having an open planar formation which absorbs tensile forces, and which is held freely stretched in a support frame made of plastic, which defines the edge profile of the footbed, with the aid of a cover frame, and also to a device for carrying out the method.

### 2. DESCRIPTION OF THE PRIOR ART

To advantageously allow an adaptation of the footbed of a shoe to an individual foot shape, without having to relinquish a sufficient support action, molding the footbed by way of an open, preferably textile planar formation, which absorbs tensile forces, and which is held freely stretched in a support frame, which defines the edge profile of the footbed, is known (WO 2011/047 400 A1). The flexibility of the planar formation permits independent adaptation to the individual foot shape of a shoe user, wherein a shape of the unloaded planar formation, which is stretched in the support frame, this shape being necessary for the support of the foot, being ensured by the spatial edge profile of the support frame. The load of the planar formation caused by a shoe user must be dissipated to the support frame, which requires a bond having high tensile strength between the textile planar formation and the support frame. Since in particular in the case of dynamic loads of the footbed, the connection between the planar formation and the support frame is subjected to comparatively high tensile forces, typical clamp connections and glued bonds of the textile planar formation held between the support frame and a cover frame cause difficulties, and they do so not only with respect to the load-bearing capacity, but rather also with respect to the production expenditure.

### SUMMARY OF THE INVENTION

The invention is therefore based on the object of designing a method for producing a footbed of the type described at the beginning such that a secure bond having high tensile strength can be ensured between the open planar formation and the support frame with the lowest possible production expenditure.

The invention achieves the stated object in that the cover frame is molded in an integrally joined manner on the support frame through the textile planar formation during its production from a plastic melt.

As a result of this measure, because of the permeability of the open planar formation for the plastic melt for producing the cover frame, an integrally joined bond is achieved between the support frame and the cover frame after the curing of the plastic used, wherein the open planar formation is anchored in a manner having high mechanical tensile strength in the cover frame, so that the occurring tensile forces can be securely dissipated to the support frame by the open planar formation.

Using the cover frame, in the event of suitable implementation of the molding tool used, the support frame can be molded in one work step from the plastic melt, which ensures a uniform transition between the support frame and the cover frame through the open planar formation. The design expenditure linked to such simultaneous production of the support frame and cover frame may be avoided if the cover frame is molded in an integrally joined manner on the support frame during its production from the plastic melt through the open planar formation applied to the support frame. In this case, the bond of the open planar formation to the support frame along the support frame edge which defines the shape of the unloaded planar formation is achieved in one work step with the production of the cover frame, wherein prefinished support frames can be used. For the integrally joined bond between the cover frame and the support frame, for example, by injection molding of the cover frame on the support frame, it is not necessary in any case for the cover frame and the support frame to consist of the same plastic.

To also achieve mechanical interlocking between the support frame and the cover frame, in addition to the integrally joined bond, the open planar formation can be plugged on to pins which protrude beyond the support frame in the region of the cover frame to be produced, these pins then being enveloped by the plastic of the cover frame. Notwithstanding this, these pins can advantageously be used to secure the location of the open planar formation in relation to the support frame.

In order that the support function of the open planar formation stretched in the support frame can be adapted to different requirements, the planar formation itself can have differing elongation behavior in various directions, for example, due to the regional use of reinforcements or weak points. However, it is also possible to influence the elastic properties of the planar formation by applying a pre-tension. By applying different pre-tensions depending on the direction, special support effects for the footbed can in turn be achieved. For the pre-tension of the open planar formation, the planar formation can be stretched in a stretching frame.

Particularly advantageous design conditions result for a shoe to be produced with a footbed according to the invention if the cover frame is molded in an integrally joined manner through the open planar formation and at least one open upper part onto the support frame. In this case, the respective upper part can also be bonded to the support frame together with the planar formation for the footbed, wherein it is in turn possible to produce the support frame and the cover frame in one work step or to mold the cover frame onto the prefinished support frame.

For the bonding of the cover frame to the support frame through the open planar formation, it is unimportant per se whether the cover frame is produced by an injection molding method, a foaming method, or an extrusion method. If value must be placed on the external shape of the cover frame, a molding tool can advantageously be used, which is divided along the edge profile of the footbed into at least two tool parts, which clamp the open planar formation between them, one of which forms a mold cavity for the cover frame, to which a plastic melt can be applied. After the closing of the molding tool, the open planar formation, which predefines the unloaded shape of the footbed as a result of the spatial edge profile, is held fixedly clamped between the tool parts, so that only an application of a plastic melt to the mold cavity for the cover frame is still required to produce the cover frame with a penetration of the textile planar formation. If the tool part opposite to the tool part for the cover frame forms a mold cavity for the support frame, to which the plastic melt can be applied, the support frame and the cover frame can be produced in a single work step, which requires a comparatively complex tool part for the mold cavity of the support frame, however, because the open planar formation must be held freely stretched by the support frame. Simpler design conditions for the molding tool result if the tool part opposite to the tool part for the cover frame accommodates the support frame and the support frame accommodated by the tool part terminates the mold cavity of the other tool part for the cover frame. In the case of such an embodiment, an already prefinished support frame is provided, which only must be fixed in the tool part associated therewith such that it terminates the mold cavity of the tool part for the cover frame, in order to bond the cover frame in an integrally joined manner through the open planar formation on the support frame upon the application of plastic to this mold cavity.

### BRIEF DESCRIPTION OF THE DRAWING

The method according to the invention for producing a footbed for a shoe will be described in greater detail on the basis of the drawing. In the figures:

FIG. 1 shows a device according to the invention for producing a footbed in a top view of the parting plane of the tool part which accommodates the support frame,

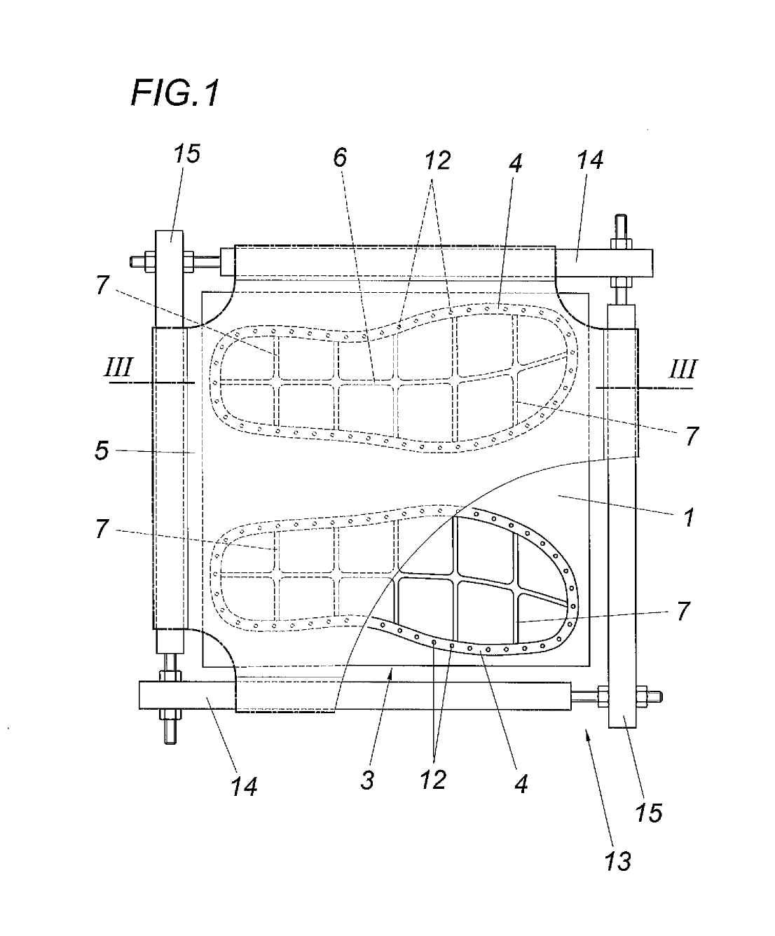

FIG. 2 shows a top view of the parting plane of the tool part which forms the mold cavity for the cover frame, and

FIG. 3 shows the device in a section along line of FIG. 1 in an enlarged scale.

### DESCRIPTION OF THE PREFERRED EMBODIMENT

The illustrated device for producing a footbed for a shoe has a molding tool 3, which is composed of two tool parts 1 and 2, and which is provided for producing footbeds for left and right shoes. Of these tool parts 1, 2, the tool part 1 accommodates a support frame 4 for an open planar formation 5, preferably a textile planar formation, such as a knitted or crocheted fabric, which is to be connected in a manner having high tensile strength to the support frame 4. The support frame 4 defines the edge profile of the footbed to be produced, which is molded by the planar formation 5 connected to the support frame 4. In order that the support frame 4 can absorb the comparatively high tensile forces from the planar formation 5, which are caused by the load of the footbed, in particular in the event of a dynamic load, the support frame 4 can be stiffened by a longitudinal web 6 and transverse webs 7, however, this is not required.

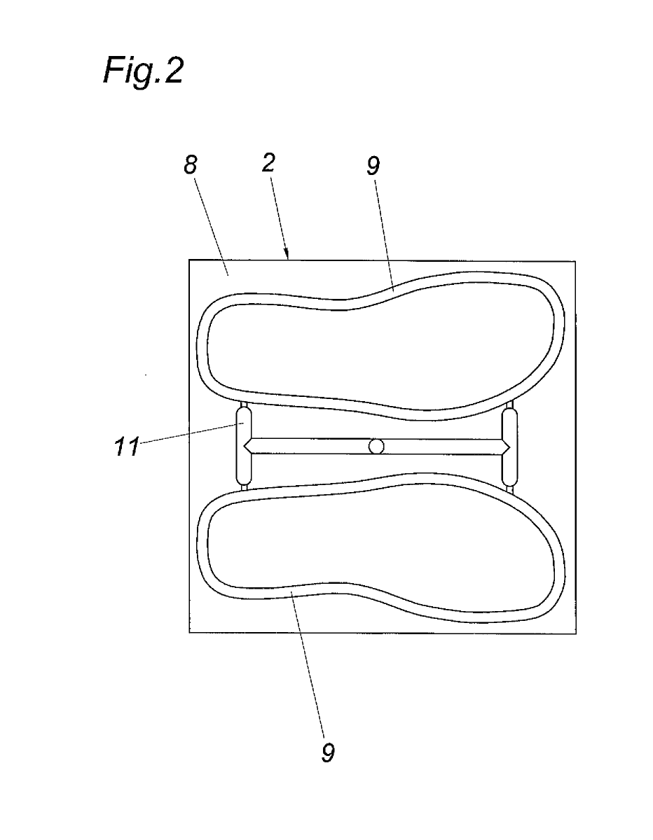

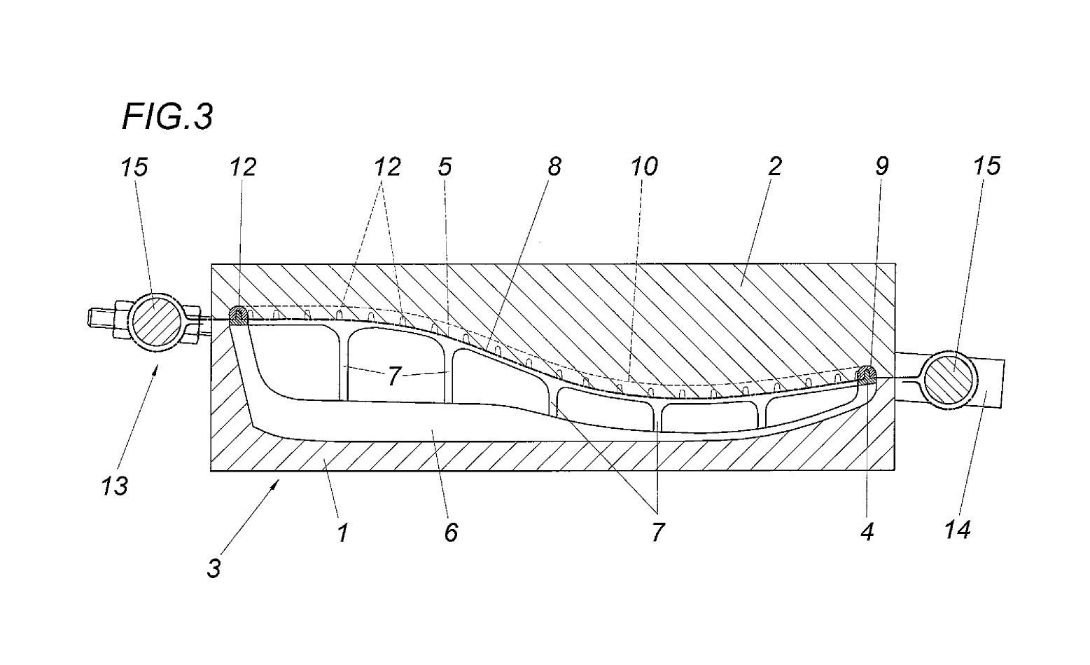

As may be inferred from FIG. 3 in particular, the edge profile of the support frame 4, which defines the shape of the footbed, lies in the parting plane 8 between the two tool parts 1 and 2, so that the planar formation 5 can be clamped between the tool parts 1 and 2 while forming the shape of the unloaded footbed. To bond the planar formation 5 to the support frame 4, a cover frame 9 is injected in an integrally joined manner onto the support frame 4 through the open planar formation 5. For this purpose, the tool part 2 forms a mold cavity 10, to which the plastic melt can be applied, and by which the support frame 4 laid in the molding tool 1 is terminated, so that during the injection molding of the cover frame 9, the bond of the planar formation 5 to the support frame 4 occurs via the plastic of the cover frame 9, which penetrates through the open planar formation 5. In FIG. 2, the runners 11 for applying the plastic melt to the mold cavity 10 are shown.

After curing of the cover frame 9, the produced footbed, which is formed by the planar formation 5 stretched in the support frame 4, can be removed from the molding tool 3 and subjected to post-processing, during which, for example, the edge section of the planar formation 5 protruding beyond the support frame 4 is cut off of the support frame 4.

To secure the location of the planar formation 5 in relation to the support frame 4, on the one hand, and to improve the bond between the cover frame 9 and the support frame 4, on the other hand, the support frame 4 can be provided with pins 12 protruding into the mold cavity 10 of the tool part 2, which penetrate the open planar formation 5 upon application to the support frame 4 and are enclosed by the plastic of the cover frame 9.

The planar formation 5, which can be manufactured from a netting, a knitted fabric, a crocheted fabric, or also from a felt or an open film, and can have inserts, reinforcements, and the like, can additionally be connected to the support frame 4 under a pre-tension, wherein different pre-tensions can be applied in particular in the longitudinal and transverse directions. For this purpose, a stretching frame 13 can be provided for the textile planar formation 5, whose opposing frame legs 14 and 15 can be set accordingly in their mutual spacing to apply a pre-tension, which optionally differs in two directions perpendicular to one another, to the planar formation 5.

Of course, the invention is not restricted to the illustrated exemplary embodiment. Thus, the support frame 4 could be produced in one work step with the cover frame 9, which requires correspondingly complex molding tools. In addition, upper parts of the shoe could be bonded to the support frame 4 together with the planar formation 5 for the footbed via a cover frame 9, if an integrally joined bond is to be produced between the cover frame 9 and the support frame 4 through the planar formation 5 and the upper part. The upper part must be open like the planar formation for this purpose, to allow passage of the plastic melt. The fact that the molding tool is to be designed accordingly for this purpose probably does not have to be separately emphasized.

1. A method for producing a footbed for a shoe having an open planar formation (5), which absorbs tensile forces, and which is held freely stretched in a support frame (4), which defines the edge profile of the footbed, with the aid of a cover frame (9), wherein the cover frame (9) is molded in an integrally joined manner onto the support frame through the open planar formation (5) during its production from a plastic melt.

2. The method according to claim 1, wherein the support frame (4) and the cover frame (9) are molded in one work step from the plastic melt.

3. The method according to claim 1, wherein the cover frame (9), during its production from the plastic melt, is molded in an integrally joined manner on the support frame through the planar formation (5) applied to the support frame (4).

4. The method according to claim 3, wherein the open planar formation (5) is plugged onto pins (12) protruding beyond the support frame (4) in the region of the cover frame (9) to be produced.

5. The method according to claim 1, wherein the open planar formation (5) is held under a pre-tension during the production and curing of the cover frame (9).

6. The method according to claim 1, wherein the cover frame (9) is molded in an integrally joined manner onto the support frame (4) through the open planar formation (5) and also through at least one open upper part.

7. A device for producing a footbed for a shoe having an open planar formation (5), which absorbs tensile forces, and which is held freely stretched in a support frame (4), which defines the edge profile of the footbed, with the aid of a cover frame (9), and having a molding tool (3), wherein the molding tool (3) is divided along the edge profile of the footbed into at least two tool parts (1, 2), which clamp the textile planar formation (5) between them, of which one forms a mold cavity (10), to which a plastic melt can be applied, for the cover frame (9).

8. The device according to claim 8, wherein the tool part (1) opposite to the tool part (2) for the cover frame (9) forms a mold cavity, to which the plastic melt can be applied, for the support frame (4).

9. The device according to claim 7, wherein the tool part (1) opposite to the tool part (2) for the cover frame (9) accommodates the support frame, and the support frame accommodated by the tool part (1) terminates the mold cavity (10) of the other tool part (2) for the cover frame (9).
